(19) United States
(12) Patent Application Publication
(10) Pub. No.: US 2025/0045301 A1
(43) Pub. Date: Feb. 6, 2025

(54) SYSTEMS AND METHODS FOR CLASSIFYING SUBSTRUCTURE IN GRAPH DATA

(71) Applicant: PAYPAL, INC., San Jose, CA (US)

(72) Inventors: Yirou Ge, Shanghai (CN); Jian Wu, Shanghai (CN); Jingwei Li, Shanghai (CN); Zhibai Wang, Shanghai (CN)

(21) Appl. No.: 18/363,668

(22) Filed: Aug. 1, 2023

(51) Int. Cl. G06F 16/28; G06F 16/22

(52) U.S. Cl. CPC G06F 16/285; G06F 16/2255

(57) ABSTRACT

There are provided systems and methods for classifying a substructure in graph data using textual descriptions derived from the graph data and hash maps generated from the textual descriptions. One or more descriptions that describe a plurality of transactions are generated based on a sequence of nodes in a set of nodes identified in a corresponding transaction of the plurality of transactions. The set of nodes represents features of the corresponding transaction. A plurality of instances is identified from the descriptions, and each instance may include a substructure including two or more nodes connected via at least one edge. For each instance, a key and a value are generated based on a hash for the instance to generate a hash map. A specific transaction is classified as an abnormal transaction based on a particular key that is excluded from the hash map.

### TECHNICAL FIELD

The present application generally relates to classifying data, and more specifically, to classifying graph data by identifying a specific substructure associated with an action using a hash map.

### BACKGROUND

A transaction between different entities normally can be represented as a graph where multiple nodes that represent a corresponding feature in the transaction are connected via edges to show their relations. For example, when Node 1 represents an account A and Node 2 represents an email address B, Node 1 and Node 2 may be connected via an edge and shown as a substructure in a graph. The substructure may represent a relation between Node 1 and Node 2 (e.g., Account A uses email address A to log in, etc.), such that, as more transactions occur, a number of repetitive substructures in the graph may increase. As a result, identifying a specific substructure from a high volume of transactions becomes time-consuming and computationally expensive (e.g., consuming a large amount of computer processing power and memory usage, etc.). For example, a specific substructure of Node A connected with Node B is hard to identify because of the number of repetitive substructures.

However, these repetitive substructures may provide important and valuable structural information, e.g., by identifying a fraud transaction trend using a substructure that includes a restricted account. As such, an improved method to efficiently detect or to classify a specific substructure in graph data, e.g., to identify repetitive substructures in the graph data, is desirable.

### BRIEF DESCRIPTION OF THE DRAWINGS

FIG. 1 is a block diagram illustrating an electronic transaction system according to an embodiment of the present disclosure.

FIG. 2 illustrates an exemplary data flow for identifying repetitive substructures according to an embodiment of the present disclosure.

FIG. 3 illustrates an exemplary description generating module according to an embodiment of the present disclosure.

FIG. 4 illustrates an exemplary data flow for generating descriptions according to an embodiment of the present disclosure.

FIG. 5 illustrates an exemplary hash map generating module according to an embodiment of the present disclosure.

FIG. 6 illustrates an exemplary data flow for grouping substructures according to an embodiment of the present disclosure.

FIG. 7 illustrates an exemplary data flow for identifying a neighbor substructure according to an embodiment of the present disclosure.

FIG. 8 illustrates an exemplary data flow for generating a new neighbor substructure according to an embodiment of the present disclosure.

FIG. 9 is a flowchart showing a process of configuring and training a machine learning model according to an embodiment of the present disclosure.

FIG. 10 is a block diagram that illustrates an example of a computing device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for classifying a substructure in graph data by identifying repetitive substructures in the graph data. As discussed above, a dataset shown as a graph might have multiple nodes to represent features of the dataset, and furthermore, every two nodes have an edge to connect each other to indicate their relation (e.g., a user account and contact information of the user in a transaction). In an industry-level demand, there can be around two million or more edges in a graph to be processed. It can be costly and time-consuming (e.g., limitation of computational efficiency) to assess each node in the graph to identify a specific substructure. As such, the present disclosure provides methods and systems to efficiently identify and consolidate repetitive substructures in the graph to improve computer processing performance.

According to various embodiments of the disclosure, a system for classifying a substructure is provided to reduce the computation processing power and memory usage when identifying repetitive substructures in graph data. The system may identify a set of nodes from the graph data and assign a label for each node identified in the graph data. For example, the graph data may represent a group of transactions, and each transaction may include a set of features that can be represented as a set of nodes in the graph data correspondingly. The label may represent a feature of the transaction, e.g., a label for “account number,” and another label for “contact information.” In addition, the label may also represent an order or weight to assess a corresponding node in the set of nodes. For example, the label for the account number may be ranked or weighted higher than the label for the contact information with certain service providers and/or systems. Thus, when generating a tree search description, the label of the account number would be described earlier than the label of the contact information. For example, the system may identify a sequence of nodes from the set of nodes based on the labels assigned to the set of nodes, such that the sequence of node may indicate an order to visit nodes in the sequence of nodes to generate a description (e.g., describing a node that has the highest-ranked/weighted label first, and then a node that has the same tier or a next tier label than the highest-ranked label), until all the nodes in the set of nodes have been visited. With these textual descriptions generated based on the labeled and ranked or weighted nodes, a part of repetitive substructures can be identified. For example, the substructures that share the same descriptions (e.g., within a similar threshold) may only be processed once when the system performs pattern analysis.

Furthermore, the system may generate a hash map, including a substructure hash map and an overlapping hash map, to provide an efficient way to consolidate repetitive substructures and search for a specific substructure. The substructure hash map may include keys and values for substructures identified from the descriptions generated using the labeled and ranked nodes. Such substructures that have the same descriptions may share the same keys and values. By sharing keys and values in the substructure hash map, the system may significantly reduce processing time to locate a specific substructure without the necessity of going through each substructure in the graph data. In addition, the overlapping hash map may provide keys and values to common edges identified in the substructures in the graph data, such that the system may group certain substructures based on a number of common edges they share and extend the depth of analysis to connect potential transactions. For example, the system may classify a transaction by looking into its keys and values computed based on its substructures, and group the transaction with a certain grouped substructure to determine whether this transaction is abnormal (which can include fraudulent transactions, transactions requiring additional processing, such as further authentication, transactions exceeding limits, etc.). For example, the keys and values are excluded from the substructure hash map and the overlapping hash map, or a number of the keys and values that matches the keys and values in the substructure hash map and the overlapping hash map is less than a threshold, which then indicates an abnormal transaction. Therefore, the system may efficiently process and identify repetitive substructures by generating textual descriptions for graph data and generating a hash map for substructures extracted from the textual descriptions. The system may further classify a specific substructure efficiently by comparing keys and values of the specific substructure to the keys and values in the hash map.

As a result, the system may efficiently process a graph comparing with the current solutions. For example, for a graph that includes around 1,200 to 1,600 nodes and 2,400 to 2,800 edges, the system may finish analyzing all the nodes in the graph to detect repetitive substructures in the graph faster than the existing solutions (e.g., a graph-based data mining system, Subdue) by over 40 times. Furthermore, when the existing solutions could not finish analyzing a bipartite graph that includes more than 400,000 nodes and over 1 million edges within a preset time limit, the system may finish analyzing the same analysis (e.g., discovering at least 1,800 substructures in the bipartite graph, discovering that a top one substructure has been identified at least 4,400 times, and the like) under around two hours, when the existing solutions cannot complete the same analysis within the time limits. The system may improve the computer performance at least thirty times faster than any one of the existing solutions, and provide higher scalability on processing a large graph. In addition, the system may require less parameters to analyze a graph and may support processing a larger size of graph than the existing solutions.

As discussed above, by utilizing the approaches including generating descriptions for graph data and generating hash maps for substructures identified from the descriptions, the system for classifying a specific substructure may apply to many use cases. In some embodiments, the system may be utilized with an artificial intelligence (AI) chatbot. Each node in graph data may represent a sentence or a message from a user or from/by the AI chatbot, and related messages can be connected by edges. In this case, the system may be utilized to identify repetitive patterns in correspondence between users and the AI chatbot's server to establish frequently asked questions, to identify common themes, and/or to customize a personalized response for a specific pattern identified between a particular user and the server. Furthermore, the system may be utilized to optimize a response to the user. For example, the system may identify patterns in the user's feedback or requests for clarification and identify irregular patterns, indicating fields that the AI chatbot is struggling to provide relevant or accurate responses. The system may be re-trained using this information to provide more effective responses in the future.

In some embodiments, the system may be utilized for sports analysis. For example, each node in graph data may represent a player in a game. Each edge between nodes may represent an interaction (e.g., a pass) between two players. The system may identify recurring patterns in a team's playing style and tactics, e.g., a substructure identified frequently might represent a particular attacking pattern. This may be used to improve playing tactics, to plan a strategy against a specific player in opponent teams, and the like. Furthermore, the system may also be used in scouting to identify recurring patterns in a player's behavior that matches the team's playing style by analyzing player performance graph data.

In some embodiments, the system may be used in artificial intelligence, e.g., natural language processing, computer vision, and autonomous vehicles. For example, the system may identify recurring patterns in visual data, such as common object shapes or textures. This may improve computer vision algorithms, such as object recognition or image segmentation. In some embodiments, the system may identify frequently occurring phrases or structures in text data, such as common sentence structures or language patterns. This may improve natural language processing algorithms and applications, such as chatbots or machine translation. In some embodiments, the system may identify recurring patterns in traffic data, such as common congestion points or accident-prone areas, and help autonomous vehicles make more informed decisions and navigate safely.

In some embodiments, the system may be used in the technology industry, for example, fraud trend detection, cybersecurity, social networks and marketing analysis, recommendation systems, and the like. For example, the system may identify suspicious patterns (e.g., an abnormal or infrequent substructure) in financial transaction networks, such as frequent transactions between certain individuals or groups. In some embodiments, the system may be used to detect recurring patterns in network traffic, such as common attack patterns or suspicious activity, and prevent cyberattacks or otherwise improve network security.

In some embodiments, the system may identify frequently occurring patterns in social networks, such as common friendship patterns or group structures, key individuals (e.g., influencers) or groups, and/or predicted user behavior in the network. In some embodiments, the system may identify recurring patterns in customer behavior (e.g., repetitive substructures including nodes representing shopping websites and a purchase amount). These patterns may indicate common buying habits or response to marketing campaigns, which may be used to optimize marketing strategies and/or increase customer engagement. In some embodiments, the system may be used to identify common patterns in user behavior (e.g., a repetitive substructure including two nodes representing a user and a website), such as frequently visited websites or purchased items. This may allow the system to improve recommendation systems that suggest new content or a specific product based on the common patterns.

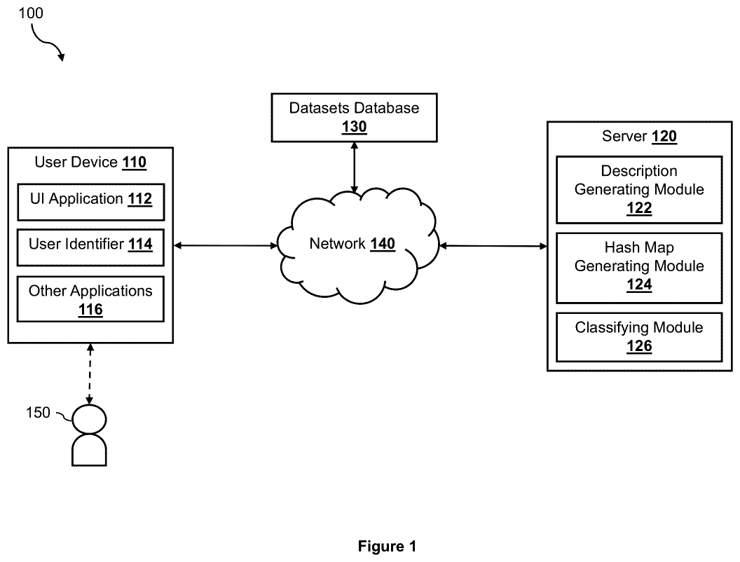

FIG. 1 illustrates a substructure identifying system 100 according to one embodiment of the disclosure. The substructure identifying system 100 includes a user device 110, a server 120, and a datasets database 130 that may be communicatively coupled with each other via a network 140. The datasets database 130, in one embodiment, may be a database storing a plurality of datasets usable as input values for various machine learning models (e.g., data for analyzing recurring patterns, etc.) which are accessible by the server 120. The network 140, in one embodiment, may be implemented as a single network or a combination of multiple networks. For example, in various embodiments, the network 140 may include the internet and/or one or more intranets, landline networks, wireless networks, and/or other appropriate types of communication networks. In another example, the network 140 may comprise a wireless telecommunications network (e.g., cellular phone network) adapted to communicate with other communication networks, such as the Internet.

The user device 110, in one embodiment, may include a user interface (UI) application 112 (e.g., a web browser, a mobile payment application, etc.), which may be utilized by a user 150 to interact with the server 120 over the network 140. In one implementation, the user interface application 112 may include a software program (e.g., a mobile application) that provides a graphical user interface (GUI) for the user 150 to interface and communicate with the server 120 via the network 140. In another implementation, the user interface application 112 may include a browser module that provides a network interface to browse information available over the network 140. For example, the user interface application 112 may be implemented, in part, as a web browser to view information available over the network 140. Thus, the user 150 may use the user interface application 112 to initiate electronic transactions (e.g., login transactions, data access transactions, electronic payment transactions, etc.) with the server 120. For example, the user 150 may, via the user device 110, log into their account and make a payment via the server 120. The server 120 may determine a set of data associated with the payment, such as data provided by the user 150 via the user device 110, data associated with the user device 110 obtained by the server 120, and data generated by the server 120 in association with the payment, etc. For example, the server may determine an account number, the amount of the payment, a transaction history associated with the user device 110, an IP address of the user device 110, etc. In some embodiments, the inputs regarding the electronic transaction at the user device 110 may be sent to the datasets database 130 as a dataset for configuring and training a machine learning model for a specific task, e.g., a machine learning model for detecting a fraudulent transaction.

The user device 110, in various embodiments, may include other applications 116 as may be desired in one or more embodiments of the present disclosure to provide additional features available to the user 150. In one example, such other applications 116 may include security applications for implementing client-side security features, programmatic client applications for interfacing with appropriate application programming interfaces (APIs) over the network 140, and/or various other types of generally known programs and/or software applications. In other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the server 120 via the network 140, and the identifier 114 may be used by the server 120 to associate the user 150 with a particular user account (e.g., a particular profile).

In various implementations, the user 150 may be able to input data and information into an input component (e.g., a keyboard) of the user device 110. For example, the user 150 may use the input component to interact with the UI application 112 (e.g., to conduct a purchase transaction via the server 120).

In some embodiments, the user device 110 may be an internal device within an operational environment of the server 120 and the datasets database 130. The user may use the user device 110 to initiate and operate a transaction classifying process at the server 120. In some embodiments, the user may submit a request to build a hash map for classifying transactions. The server 120 may prompt the user for datasets associated with the request, including datasets associated with user profiles, datasets associated with historic transaction, and any datasets that are usable for analyzing patterns in the transactions. Thus, the server 120 may obtain the datasets associated with the request from the datasets database 130. In some embodiments, the user may submit a request to classify a particular transaction. The server 120 may prompt the user for datasets associated with the request, such as a dataset associated with the particular transaction.

The datasets database 130 may store one or more datasets, for example, including training datasets for training various machine learning models maintained by the server 120, datasets of user profiles, datasets associated with historic transactions, etc. The various machine learning models may be accessible by the server 120 and may also be used by the server 120 for performing various tasks. For example, the datasets database 130 may store the datasets associated with the historic transactions for the server 120 to analyze recurring patterns in the historic transactions, so that the server may detect a potential fraudulent transaction if the potential fraudulent transaction indicates an abnormal pattern while comparing the historical transactions.

As discussed herein, the datasets database 130 may include datasets usable as input data for analyzing recurring patterns in transactions or classifying a particular transaction from the transactions (e.g., excluding repetitive substructures in graph data to identify a particular transaction). Thus, the datasets database 130 may include first datasets associated with user profiles (e.g., data including user personal information, a user account number, and/or user preference settings in the user interface application 112). The datasets database 130 may include second datasets associated with historic transactions (e.g., data including a user (or sender) account number, a currency type of a transaction, a recipient's account number, a date of a transaction, and an IP address). The first datasets and the second datasets may both be usable for analyzing recurring patterns in transactions. In some embodiments, input features in each of the datasets may overlap, partially overlap, or be mutually exclusive. For example, the first datasets may include data values corresponding to five input features, such as a username, a user account number, a currency type of a transaction, a date of the transaction, and an IP address, while the second datasets may include data values corresponding to three input features, such as a user account number, a currency type of a transaction, and a recipient's account number.

In various embodiments, the datasets in the datasets database 130 may be graph data, textual data, image data, and/or sensor data. In one embodiment, the datasets database 130 may include graph data that have a bipartite structure.

The server 120, in various embodiments, may be any of various types of computer servers, e.g., a cluster of computers in a server farm, capable of serving data to other computing devices, including user device 110, via network 140. The server 120 may be associated with different types of entities or systems, such as, but not limited to, various service providers, including payment or transaction service providers. In some embodiments, the server 120 may include a description generating module 122, a hash map generating module 124, and a classifying module 126.

Upon receiving a request to conduct a transaction (e.g., making a payment to an entity) from the user 150 via the user device 110, the description generating module 122 may obtain a dataset associated with a transaction and identify a set of nodes from the dataset. Each node in the set of nodes may represent features of the transaction (e.g., account number, transaction amount, IP address, etc.). For example, the set of nodes identified from the transaction may correspond to a group of features including a user account number, a currency type of a transaction, a recipient's account number, a date of the transaction, and an IP address. Node 1 may represent the user account, Node 2 may represent the currency type of a transaction, Node 3 may represent a recipient's account number, Node 4 may represent the date of the transaction, and Node 5 may represent the IP address. Each node of the set of nodes may be connected to at least one other node in the set of nodes via an edge. For example, Node 1 may be connected to Node 2 via an edge, Node 2 may be connected to Node 1, Node 3, and Node 4 via three individual edges, and Node 4 may be connected to Node 2 and Node 5 via two edges individually. Based on a corresponding feature of a node in the set of the nodes, each node may be assigned a label or weight which determines its order to be assessed for generating a description. For example, Node 1 representing the user account may be labeled Red and Label Red is the highest-ranked label, such that Node 1 has the highest priority and will be assessed first among all other nodes when generating the description for the set of nodes. The description generating module 122 may generate the description for the set of nodes sequentially based on their respective labels or weights (e.g., generating a description to describe nodes sequentially based on their labels).

Based on the description of the set of nodes, the hash map generating module 124 may identify instances (e.g., an instance may include one or more substructures) from the description, and each instance may include two or more nodes connected via at least one edge. For example, Instance 1 may include Node 1 connecting Node 2 via Edge 1, Instance 2 may be Node 2 connecting Node 3 via Edge 2, Instance 3 may be Node 2 connecting Node 4 via Edge 3, and so forth. For each instance of the instances, the hash map generating module 124 may generate a key and a value based on a corresponding hash for the instance. In some embodiments, the hash map generating module 124 may identify a common edge by comparing the instances of the transaction to instances of historic transactions (e.g., instances that are previously identified by the server 120 based on the historic transactions and are stored in the datasets database 130). If there is a common edge between the instances of the transaction and the instance of the historic transactions, the hash map generating module 124 may generate a key and a value based on a hash for the common edge. For example, Edge 1 of Node 1 (the user account) connecting Node 2 (the currency type of the transaction) may also appear in a historic transaction, such as the same user account making a transaction in the same currency type but to a different recipient). In some embodiments, the hash map generating module 124 may generate a substructure hash map and an overlapping hash map based on the keys and values generated based on the transaction and the historic transactions. These keys and values generated by the hash map generating module 124 may be used to classify the transaction.

For example, the classifying module 126 may compare the keys and values of the transaction to keys and values of the historic transactions, and detect recurring patterns shown in both of the transaction and the historic transactions (e.g., repetitive substructures identified) using the keys and values of the transaction to search corresponding keys and values in the pre-built substructure hash map and overlapping hash map. The classifying module 126 may classify the transaction as a safe transaction (e.g., a non-fraudulent transaction). In one embodiment, the classifying module 126 may classify the transaction as an abnormal transaction (e.g., a fraudulent transaction) when there are no corresponding keys and values identified in the pre-built substructure hash map and overlapping hash map. This may occur when the keys and values of the transaction are excluded from the pre-built substructure hash map and overlapping hash map.

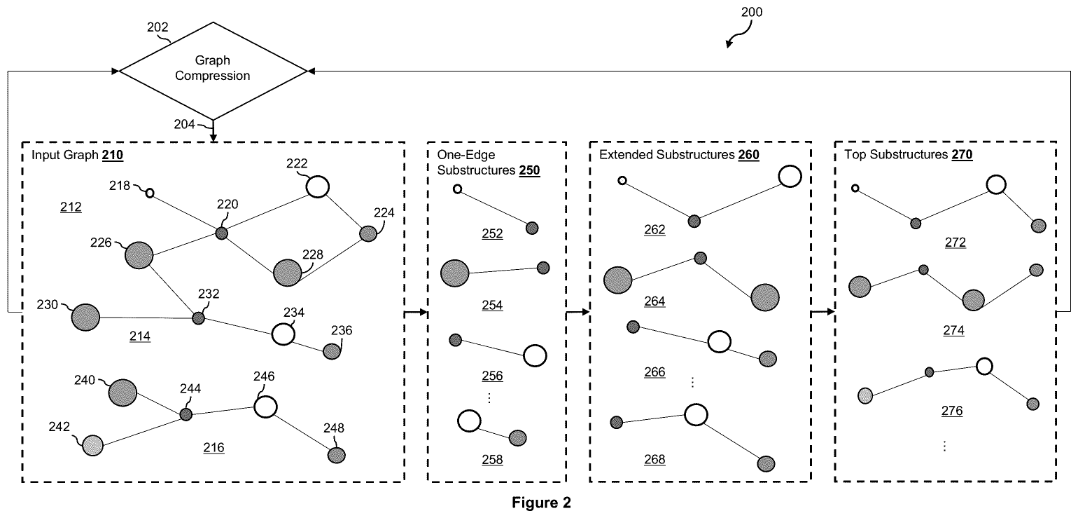

FIG. 2 illustrates an exemplary data flow 200 for identifying repetitive substructures according to various embodiments of the disclosure. In some embodiments, the example data flow 200 may be performed by the description generating module 122 and the hash map generating module 124 at the server 120. In a process of identifying repetitive substructures in a graph, the description generating module 122 may receive an input graph 210 from the user device 110 and/or the dataset database 130, and the input graph 210 may include various sets of nodes representing multiple transactions. For example, the input graph 210 may include transactions 212, 214, 216. Each of the transactions 212, 214, 216 includes a set of features that may be shown in connected nodes. The transaction 212 may include nodes 218, 220, 222, 224, 226, 228 representing a set of features of the transaction 212, the transaction 214 may include nodes 230, 232, 234, 236 representing a set of features of the transaction 214, and the transaction 216 may include nodes 240, 242, 244, 246, 248 representing a set of features of the transaction 216. The description generating module 122 may identify these nodes in the transactions 212, 214, 216 based on their corresponding features and label these nodes. For example, the description generating module 122 may identify that the nodes 226, 228, 230, 240 are nodes representing the same type of feature, e.g., account number. The description generating module 122 may label the nodes 226, 228, 230, 240 the same label, e.g., Label Green. In some embodiments, the nodes 226, 228, 230, 240 do not have to be the same account number, e.g., the node 226 may represent Account Number A and the node 228 may represent Account Number B. As long as the nodes 226, 228, 230, 240 represent the same type of feature, the nodes 226, 228, 230, 240 will be assigned the same type of label. In some embodiments, the type of feature that each node represents may not be determined by the system 100, but assigned by the user 150 as an attribute of each node. For example, in response to each use case, the user 150 may assign a type of feature for each node shown in the input graph 210.

In some embodiments, the node 226 of the transaction 212 and the node 232 of the transaction 214 might not occur in the same transaction, but the node 226 and the node 232 might connect with each other in another transaction or in a historic transaction. For example, the node 226 may represent an account A and the node 232 may represent an IP address in France. While the account A (e.g., the node 226) in the transaction 212 may perform the transaction 212 in the United States (e.g., the node 220 may present an IP address in the United States), the account A (e.g., the node 226) may also have a historic transaction performed via the IP address in France (e.g., the node 232). The system 100 may link the node 226 with the node 332 as well, despite that they may not connect with each other in the current dataset.

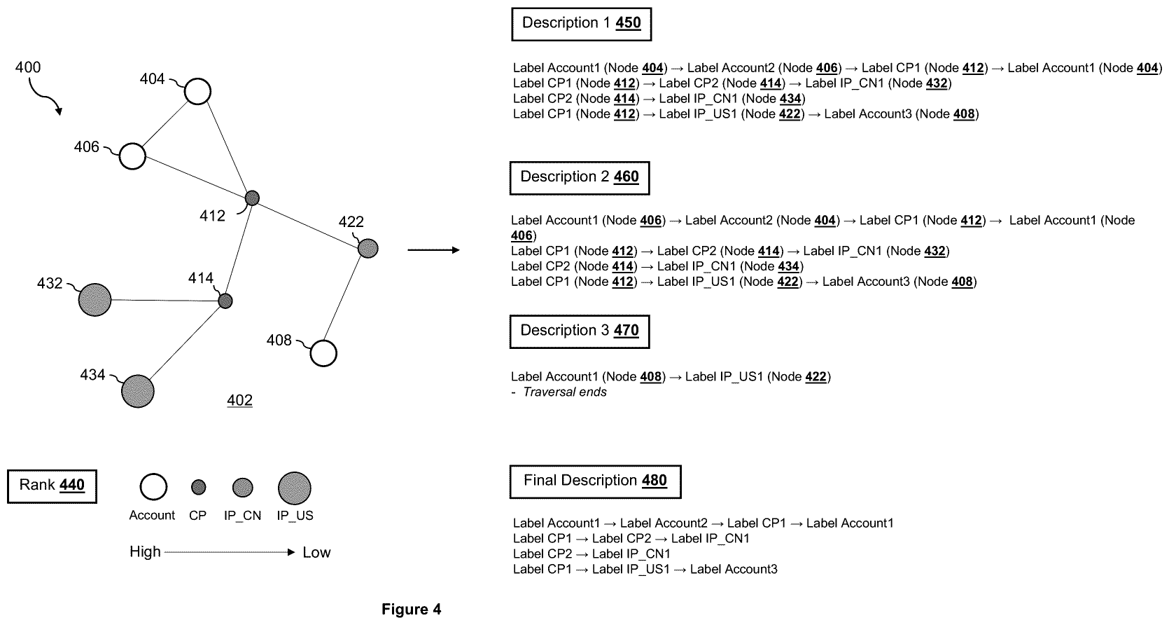

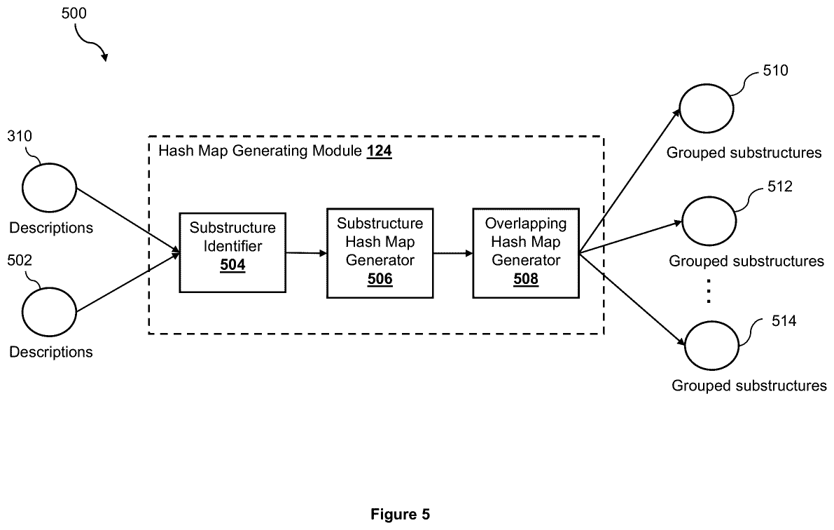

The description generating module 122 may generate a description for each of the transactions 212, 214, 216 based on their nodes sequentially according to their respective labels, which will be described in detail in FIGS. 4-5. For example, the nodes 230, 232, 234, 236 of the transaction 214 are each labeled with Label Green (account number), Label Blue (currency type), Label White (entity size), and Label Orange (contact information) respectively. The description generating module 122 may assign a rank to each label based on its corresponding feature, and the rank may determine an order to assess the nodes. In some embodiments, the rank for the labels may be assigned by the user 150 or based on a specific task. For example, Label Green may be ranked higher than Label Blue if the task is to monitor activities on a specific account, and Label Blue may be ranked higher than Label White, Label White may be ranked higher than Label Orange. When the description generating module 122 generates a description for the transaction 214, the description will describe firstly the node 230 (Label Green), the node 232 (Label Blue), the node 234 (Label White), and finally, the node 236 (Label Orange). In some embodiments, the description generated by the description generating module 122 may be a textual description, such that the system 100 may reduce processing time to analyze the recurring patterns (e.g., repetitive substructures) in the transactions. Other types of descriptions or labels can be numbers, alphanumeric, single words, images, and the like.

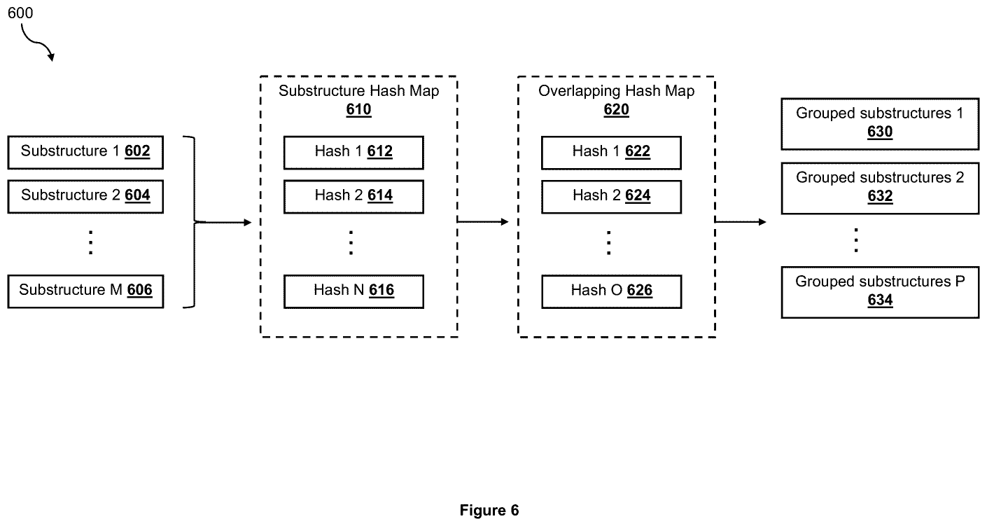

Based on these descriptions generated by the description generating module 122, the hash map generating module 124 may identify a group of one-edge substructures 250 from the descriptions, including substructures 252, 254, 256, 258, and so forth, which will be described in detail in FIGS. 5-6. For example, from the description generated for the transaction 214, the hash map generating module 124 may extract the substructure 252 (i.e., the node 218 (Label Yellow) connected to the node 220 (Label Blue)), the substructure 254 (i.e., the node 230 (Label Green) connected to the node 232 (Label Blue)), the substructure 256 (i.e., the node 232 (Label Blue) connected to the node 234 (Label White)), and the substructure 258 (i.e., the node 234 (Label Blue) connected to the node 236 (Label Orange)). The hash map generating module 124 may perform a hash function for each of the substructures and generate a key and a value for a hash of a substructure for an efficient identification. For example, the hash map generating module 124 may look into a number of instances (e.g., instances representing multiple requests from users) in the input graph 210 to identify a specific substructure therein. The instances in the input graph 210 may include some common nodes and common edges with each other, which indicates that there might be some repetitive substructures among the instances. In some embodiments, an instance may be a substructure identified by the hash map generating module 124. As a result, for the substructures that share the same description (e.g., the substructure 254 can be found in all of the transactions 212, 214, 216), they are assigned the same key and value, such that the system 100 may be able to analyze how many substructures are repeatedly identified in the transactions efficiently.

Furthermore, the hash map generating module 124 may identify extended substructures 260 based on the one-edge substructures 250. For example, based on the one-edge substructures 250, the hash map generating module 124 may identify a next node which is an edge apart from a node in the one-edge substructures 250, and extract substructures 262, 264, 266, 268, and so forth. The substructure 262 may include the nodes 218, 220, 222 which is extended from the one-edge substructure 252 to include the node 222 in the substructure 262. In some embodiments, the step of extending one-edge substructures 250 may be performed iteratively to identify a substructure that is one or more edges apart from the nodes in the one-edge substructures 250 as needed. Likewise, the hash map generating module 124 may perform a hash function for each of the substructures in the extended substructures 260 and generate a key and a value for a hash of a substructure.

By analyzing the keys and values generated by the hash map generating module 124 for the substructures identified from the transactions, the system 100 may be able to provide top substructures 270 that have been identified the most frequent in the transactions. For example, the top substructures 270 includes substructures 272, 274, 276 that are the top three substructures identified in the transactions. As the hash map grows with more identified substructures, the system 100 may provide more solid reference (e.g., recurring patterns/repetitive substructures) to classify a transaction. In some embodiments, for identifying the top substructures 270, the hash map generating module 124 may utilize a score function to evaluate each of the extended substructures 260 based on its repetitiveness (e.g., how many times each of the extended substructures 260 has appeared in the input graph 210) and its complexity (e.g., how many nodes/edges each of the extended substructures 260 has). For example, a basic score function embedded into the algorithm may be:

$$score = float ( ( pattern . n\_distinct \_edges \_covered / graph . n\_edges + pattern . n\_distinct \_vertices \_covered / graph . n\_vertices ) / 2 ) ,$$

which indicates that the average value of the percentage of edges in the input graph 210 has been covered by discovered substructures, and the percentage of vertices (e.g., nodes identified in the input graph 210) has also been covered. In some embodiments, the score function may be defined by the user 150 if the user 150 chooses to define the score function.

In some embodiments, the input graph 210 and the results of the top substructures 270 may be fed back to graph compression 202 for a next iteration 204 of the graph compression 202 for a further computation/comparison. For example, after the first iteration, the top substructures 270 have been detected from the input graph 210. In response to the detected top substructures 270, the data flow 200 may further include applying a graph compression method (e.g., the graph compression 202) to the input graph 210 which may remove nodes (e.g., vertices in the input graph 210) and/or edges that belong to the top substructures 270 (e.g., the removal of vertices and/or edges of the top substructures 270 may be a complete removal or a partial removal based on parameters set by the user 150). The purpose of removing the vertices and/or the edges of the top substructures 270 may be to continuously detect/discover more substructures from the input graph 210. For example, the input for the graph compression 202 after the first iteration may be the original input graph 210 and the detected top substructures 270, and the output from the graph compression 202 may be a compressed graph (e.g., a smaller graph comparing with the input graph 210), such that the compressed graph may be an input graph for a second iteration to detect more substructures. In some embodiments, the above steps may be repeatedly performed until the parameter limits set by the user 150.

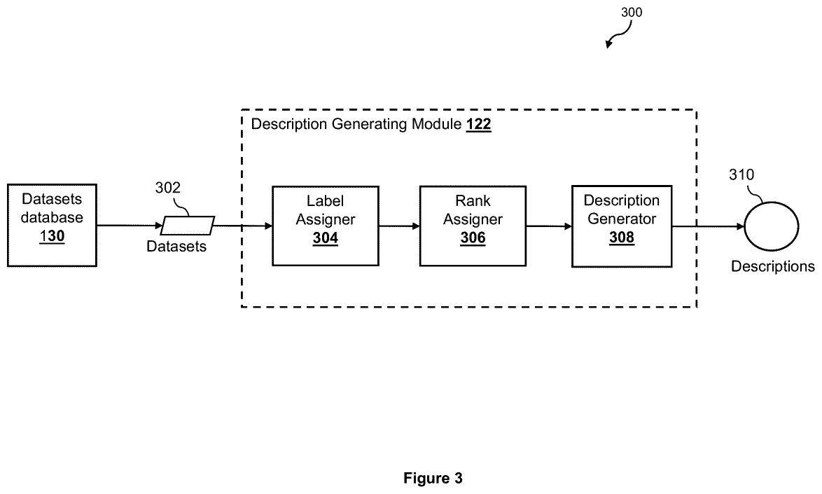

FIG. 3 illustrates an exemplary implementation 300 of the description generating module 122 according to various embodiments of the disclosure. As shown, the description generating module 122 may include a label assigner 304, a rank assigner 306, and a description generator 308. The description generating module 122 may receive datasets 302 (e.g., from the user device 110, from the datasets database 130, etc.). The datasets 302 may be usable for building a machine learning model for analyzing recurring patterns in transactions. In this example, building the machine learning model for analyzing recurring patterns in transactions may be requested by the user of the user device 110 to be built for performing a specific task (e.g., classifying transactions as fraudulent transactions or non-fraudulent transactions, etc.). In some embodiments, each dataset of the datasets 302 may include a set of nodes representing a set of features of a corresponding transaction (e.g., account number, currency type, IP address, etc). Each node of the set of nodes may be connected to at least one other node in the set of nodes via an edge to indicate its relations with the other nodes. For example, Node 1 representing a feature of “Account Number” may be connected to Node 2 representing a feature of “Contact Information” to indicate that the contact information (Node 2) might be used to verify when a user is trying to log in an account that has the account number (Node 1).

The label assigner 304 may assign a label for each node identified from the transactions according to its corresponding feature. For example, for nodes representing the same kind of feature (e.g., account numbers), these nodes are assigned the same label. In some embodiments, the labels of the nodes may be assigned by the user(s) 150 in the input graph 210, and the server 120 may support loading the input graph 210 from varying types of data sources, which may include a database table. For example, the user 150 may establish a source table and/or a database table which includes labels for the nodes in the input graph 210, so that when the server 120 loads the data and creates the graph (e.g., the input graph 210), the label assigner 304 may automatically assign the label to each node based on the input data (e.g., labels in the established source table).

The rank assigner 306 may assign a rank to a respective label, and the rank indicates an order to assess a node in the set of nodes based on its respective label. In some embodiments, the rank assigner 306 may assign the rank to the respective label according to the specific task. For example, if the system 100 receives a request to perform a task of monitoring activities on personal accounts, the label of “Account Number” will be assigned a higher rank than the label of “currency type,” such that when the description generator 308 generates a description for the transaction, the node with a higher-ranked label will be described first. In some embodiments, the labels may be ranked alphabetically, such that a rank assigning process may be an automated procedure performed by an algorithm at the server 120.

With the assigned label and assigned rank, the description generator 308 may describe the set of nodes based on their assigned labels and rank. In some embodiments, the description generator 308 may select a first node (e.g., a Parent Node that functions as the starting point of the search in each describing step) that is assigned a highest-ranked label (e.g., a label ranked the highest among all the labels) from the set of nodes. The description generator 308 may then identify a next node (e.g., a Child Node that is directly linked to the Parent Node and has the highest-ranked label among the neighbor nodes of the Parent Node) directly connected to the first node. In some embodiments, the next node may be assigned a second-ranked label having a same tier as the highest-ranked label or a next tier lower than the highest-ranked label. In some embodiments, the description generator 308 may define a Branch as a chain of nodes that are linked and visited in a sequential order. After ranking the labels from high to low, the description generator 308 may perform the graph traversal to generate descriptions 310 as the following steps:

(1) The description generator 308 may start with choosing nodes that have the highest-ranked label as root nodes (e.g., the Parent Node). For each of the root nodes, the description generator 308 may continue with an independent option of the traversal and visit all the other nodes in the input graph 210. The order of how the nodes will be visited may become the traversal result (e.g., a description of the input graph 210). The root nodes will become the first set of parent nodes in each of the following searches.

(2) For each of the root nodes, the description generator 308 may look into their neighboring nodes (e.g., nodes that are directly linked to the root node) and select the ones that have the highest-ranked label among them as the Child Nodes to visit. In some embodiments, the description generator 308 may consider one or more criteria/conditions for looking for a neighbor node for the root node: (1) if one root node does not have a neighbor with the highest-ranked label, the description generator 308 may abandon this graph traversal; (2) if there are multiple neighboring nodes with the highest-ranked label, the description generator 308 may generate multiple independent options of the traversal with each neighboring node as the next to visit.

(3) Along the graph traversal, the description generator 308 may assign a number for each node's label that has been encountered, representing the order of the traversal. If the node has a label that the description generator 308 has not visited, such as a label of Account, the description generator 308 may specify the label as Label Account1. Likewise, upon looking into the nodes in the input graph 210, if the description generator 308 encounters other nodes that also have the label of Account but with a different id, the description generator 308 may specify the nodes as Label Account2, Label Account3, etc., depending on the order when the description generator 308 visits these nodes.

In some embodiments, the description generating module 122 may use the same techniques as disclosed herein to generate descriptions for datasets usable for performing another task stored in the dataset database 130.

FIG. 4 illustrates an exemplary data flow 400 for generating descriptions, such as the descriptions 310 shown in FIG. 3, according to various embodiments of the disclosure. In some embodiments, the exemplary data flow 400 may be performed by the description generating module 122. In a process of generating descriptions for transactions in the datasets, the description generating module 122 may receive a transaction 402 and identify a set of nodes 404, 406, 408, 412, 414, 422, 432, 434 that represents a group of features of the transaction 402. The transaction 402 may include a group of instances (e.g., a transfer between two accounts, an IP address linked to an account making the transfer, etc.), and each instance may include one or more substructures that might be repetitive or identical to a substructure identified in other instances. The label assigner 304 (shown in FIG. 3) of the description generating module 122 may assign a label to each node in the set of nodes according to a respective feature that the node represents. For example, the nodes 404, 406, 408 represent Account A, Account B, and Account C respectively, the label assigner 304 (e.g., assigning a label as an attribute by the user 150) loads/assigns a Label Account (the label of white) for the feature of “account” to the nodes 404, 406, 408, and so forth.

When all the nodes in the set of nodes have been assigned their label based on their respective feature, the rank assigner 306 may assign a rank 440 to each label to determine an order to assess a node in the set of nodes when generating a description. In some embodiments, the rank of the labels may ensure that different substructures may have different descriptions, and the same substructure may have the same description. In some embodiments, the score function which evaluates the discovered substructures may be customized based on a specific task, such as, for example, detecting a fraudulent transaction trend. In another example, if the system 100 (shown in FIG. 1) needs to analyze an attacking pattern of a specific soccer player, the user 150 may assign a weight to the type of the label (e.g., a label of the attacking pattern) contained in the substructure in the score function, such as substructures containing a label representing a feature of “Count of Cross Pass” may have a higher score than substructures containing a label representing a feature of “Minutes Played Per Game.”

With the nodes labeled with the rank 440, the description generator 308 may identify first nodes in the set of nodes (e.g., nodes with the highest-ranked label) to start generating descriptions. For example, there are three nodes 404, 406, 408 with the highest-ranked label, the description generator 308 may generate a Description 1 450, a Description 2 460, and a Description 3 470 using the nodes 404, 406, 408 as a starting point individually. The description generator 308 may then identify a next node for the first node. The next node may include a plurality of next nodes. In some embodiments, the next node may be assigned a second-ranked label having a same tier as the highest-ranked label or a next tier lower than the highest-ranked label. For example, when the first node is the node 404, there are two nearby nodes 406, 412 that could potentially be the next node for the node 404. The description generator 308 may look into the two nearby nodes 406, 412 and notice that the node 406 has a label that is ranked higher than the node 412's label, such that the next node for the node 404 (e.g., the first node) is the node 406, instead of the node 412. In some embodiments, the description generator 308 may identify the next node based on the rank of the unvisited neighboring nodes. For example, in Branch 1 of Description 1 450, for identifying a next node for the node 412, its unvisited neighboring nodes are the nodes 406, 414, and 422 (e.g., the unvisited neighboring nodes for the node 412 refer to the nodes that are directly linked to the node 412 and their link in between, which has not been visited before). Since the node 404 has a higher rank than the node 414 and the node 422, the next node for the node 412 is the node 404 as described in a final description 480. In some embodiments, the description generator 308 may identify a next node that connects with most nearby nodes. For example, when the next node is the node 412 and the description generator 308 is going to identify a next node for the node 412, the description generator 308 may select the node 414 as the next node for the node 412 first, because the node 414 has more nearby nodes than the node 422. After identifying the plurality of next nodes, the description generator 308 may identify a final node which has no nearby node, which has not been assessed for this sequence of nodes that the description is going to describe sequentially. For example, the description generator 308 may generate the Description 1 450 for the transaction 402 to describe an identified sequence of the first node, the next node, and the final node; as in: Label White (Node 404)-Label White (Node 406)-Label Blue (Node 412)-Label White (Node 404)-Label Blue (Node 414)-Label Green (Node 432)-Label Green (Node 434)-Label Orange (Node 422)-Label White (Node 408).

As discussed in FIG. 3, in some embodiments, the description generating module 122 may have three root nodes 404, 406, and 408, all with the Label Account, to generate the descriptions for the input graph. The node 406 is directly linked to the node 404 (Label Account) and the node 412 (Label Counter Party (CP)), the node 404 is directly linked to the node 406 (Label Account) and the node 412 (Label CP), and the node 408 (Label Account) is directly linked to the node 422 (label: IP_CN). Per the criteria discussed in FIG. 3, the highest-ranked label among the neighboring nodes of the root nodes (e.g., the nodes 404, 406, and 408) is Label Account, and because the node 408 does not have a neighbor node with Label Account, the description generating module 122 may abandon the traversal starting from the node 408. Furthermore, since the nodes 406 and 404 both have neighbor nodes with Label Account, the description generating module 122 may choose either neighbor nodes as the next to visit.

When choosing the node 404 as a root node to generate a description (Description 1 450), the description generating module 122 may specify the node 404 as Label Account1, and specify the node 406 as Label Account2, since the description generating module 122 visits the node 404 first. When choosing the node 406 as a root node to generate a description (Description 2 460), the description generating module 122 may specify the node 406 as Label Account1, since it is visited first. Therefore, the description generating module 122 may generate two descriptions (Description 1 450 and Description 2 460) of the traversal: Description 1 450: Label Account1 (Node 404)→Label Account2 (Node 406), and Description 2 460: Label Account1 (Node 406)→Label Account2 (Node 404). Furthermore, the description generating module 122 may repeat the previous step (e.g., using the last child nodes, i.e., the node 406 in Description 1 450 and the node 404 in Description 2 460), as the new parent nodes to identify a next highest-ranked neighbor node as the new child nodes to visit and add them into the traversal record (e.g., Description 1 450 and Description 2 460) while ignoring the already visited links. For example, the node 406 in Description 1 450 and the node 404 in Description 2 460 may become the new parent node. The node 406 is linked to the node 412 (Label CP), and the node 404 is linked to the node 412 (Label CP), the description generating module 122 may ignore the link between the node 406 and the node 404 because this link has been visited in the last step. Among their neighbor nodes, the description generating module 122 may identify that the node 412 has the higher-ranked label, so that the description generating module 122 may continuously perform the traversal as: Description 1 450: Label Account1 (Node 404)→Label Account2 (Node 406)→Label CP1 (Node 412), and Description 2: Label Account1 (Node 406)→Label Account2 (Node 404)→Label CP1 (Node 412).

The description generating module 122 may continuously repeat the above steps until the new parent node(s) have no neighbor nodes. The description generating module 122 may return to the last parent node and continue the traversal (e.g., Description 1 450 and Description 2 460) by adding a new branch. For example, in the next step for both Description 1 450 and Description 2 460, the description generating module 122 may find that the node 412 is linked back to the nodes 404, 406, and the nodes 404, 406 have no remaining neighbor nodes that have not been visited. Therefore, after adding the nodes 404, 406 in the traversal as the end of the first branch, the description generating module 122 may return to the node 412 as the parent node, and initiate a new branch. The description generating module 122 may identify the remaining neighbor nodes 414, 422 for the node 412, and select the node 414 as the next to visit as it has a higher-ranked label. Therefore, the traversal becomes: Description 1 450: Label Account1 (Node 404)→Label Account2 (Node 406)→Label CP1 (Node 412)→Label Account1 (Node 404)→(New Branch) Label CP1 (Node 412)→Label CP2 (Node 414), and Description 2 460: Label Account1 (Node 406)→Label Account2 (Node 404)→Label CP1 (Node 412)→Label Account1 (Node 406)→(New Branch) Label CP1 (Node 412)→Label CP2 (Node 414). The description generating module 122 may repeat the above step (e.g., adding a new branch) until all the nodes in the graph have been visited and added into the traversal result by the visiting order.

After abandoning inferior traversal options (e.g., Description 3 470), the description generating module 122 may select one description (e.g., Final Description 480) for this graph (e.g., there is either one description or multiple identical descriptions, such as Description 1 450 and Description 2 460 that are identical). For example, Final Description 480 for this substructure shown in FIG. 4 may be Label Account1→Label Account2→Label CP1→Label Account1→(New Branch) Label CP1→Label CP2→Label IP_CN1→Label CP2→Label IP_CN1→Label CP1→Label IP_US1→Label Account3, which may include the information of the labels but no specific information of the nodes. Therefore, the description generating module 122 may output an unique description for each different substructure to improve processing speed and efficiency when identifying a specific substructure.

In some embodiments, the description generator 308 abandons a description when the next node for the first node has a lower-ranked label than its nearby node's label. For example, when the description generator 308 generates the Description 3 470 using the node 408 (e.g., a node with the highest-ranked label) as the first node, the next node that is nearby and available for the node 408 is the node 422. However, the node 422 only has a nearby node (e.g., the node 412) that has a label ranked higher than the node 422 itself. In this case, the description generator 308 will abandon the Description 3 470 because the Description 3 470 might be inferior to the Description 1 450 and the Description 2 460 in terms of disobeying the rank to generate the descriptions for the transactions, which may eventually affect the accuracy of outputs.

In some embodiments, the description may be in a formality of text to reduce the processing time. In some embodiments, the description generator 308 may generate the same contents for the Description 1 450 and the Description 2 460 because of the rank of the label and the connections between the nodes in the transactions 402. In this case, the system 100 may only consider one description for the transaction 402 for a future analysis to facilitate processing time (e.g., reducing the complexity of assessing nodes in a graph).

FIG. 5 illustrates an exemplary implementation 500 of the hash map generating module 124 according to various embodiments of the disclosure. As shown, the hash map generating module 124 includes a substructure identifier 504, a substructure hash map generator 506, and an overlapping hash map generator 508. In some embodiments, the substructure identifier 504 may receive various sets of descriptions (e.g., the final description 480) that have been generated by the description generating module 122 (as shown in FIG. 4), including a first set of descriptions 310, a second set of descriptions 502, and others. Each set of the descriptions may be generated based on its corresponding datasets. For example, the first set of descriptions 310 may correspond to the transactions in the datasets 302, and the second set of descriptions 502 may correspond to transactions in another set of datasets.

Referring back to FIG. 4, in some embodiments, the substructure identifier 504 may identify a group of substructures (e.g., a substructure of Label Account (Node 406)→Label CP (Node 412)→Label IP_US (Node 422)→Label Account (Node 408) that represents a transfer from Account 1 to Account 2) from the descriptions 310, 502. Each substructure may be extracted from the descriptions 310, 502. The substructure may include two or more nodes connected via at least one edge (e.g., a substructure of Label White (Node 404 or Node 406) connecting to Label Blue (Node 412)), as shown in FIG. 4. In some embodiments, the substructure identifier 504 may indicate how many times a substructure is identified in the input descriptions. For example, the substructure of Label White connecting to Label Blue has been identified twice in the transaction 402.

In some embodiments, the substructure hash map generator 506 may perform a hash function to the group of substructures identified by the substructure identifier 504. For each substructure of the substructures, the substructure hash map generator 506 may generate a key and a value based on a hash for each substructure. The key for the substructure may include a description of the substructure, and the value for the substructure may include an identifier for the substructure. For example, for those substructures that share the same description (e.g., having the same substructure), those substructures may share the same hash (e.g., the same key and value) in the substructure hash map.

In some embodiments, the overlapping hash map generator 508 may identify a group of common edges in the plurality of substructures. For example, the overlapping hash map generator 508 may identify a common edge among a substructure of Label White (e.g., Node 406)-Label Blue (e.g., Node 412)-Label Orange (e.g., Node 422) and a substructure of Label White (e.g., Node 406)-Label Blue (e.g., Node 412)-Label Blue (e.g., Node 414), i.e., the edge between Label White (Node 406) and Label Blue (Node 412) is the common edge among the above two substructures. For each common edge of the group of common edges, the overlapping hash map generator 508 may generate a key and a value based on a hash for the common edge. The key for the common edge may include a description of the common edge, and the value for the common edge may include an identifier for substructures sharing the common edge.

In some embodiments, for those substructures that share the most keys and values, the hash map generating module 124 may group them together and output grouped substructures 510, 512, 514, and so forth. Based on these grouped substructures, the system 100 may readily classify a transaction (e.g., group the transaction into a particular group of substructures based on how many keys and values that the transaction and the particular group of substructures share, or whether the count of shared keys and values surpass a threshold set by a user). Such that, the system 100 may classify the transaction as a non-fraudulent transaction based on the characteristics of the group of substructures that the transaction has been grouped into.

FIG. 6 illustrates an exemplary data flow 600 for grouping substructures according to various embodiments of the disclosure. In some embodiments, the exemplary data flow 600 may be performed by the substructure hash map generator 506 and the overlapping hash map generator 508. In a process of grouping substructures, the substructure hash map generator 506 may receive various sets of substructures (e.g., a substructure or an instance representing requests made by the user 150 and/or other users), including a substructure 1 602, a substructure 2 604 . . . , and a substructure M^{th} 606 from the substructure identifier 504 disclosed in FIG. 5. The substructure hash map generator 506 may perform hash functions to each substructure (e.g., Hash 1 612, Hash 2 614 . . . , and Hash N^{th} 616), to build a substructure hash map 610. Furthermore, the overlapping hash map generator 508 may identify a group of common edges in the substructure 1 602 to the substructure M^{th} 606, and perform hash function to each common edge (e.g., Hash 1 622, Hash 2 624 . . . , and Hash O^{th} 626), to build an overlapping hash map 620. Based on the substructure hash map 610 and the overlapping hash map 620, the hash map generating module 124 may group substructures, including grouped substructure 1 630, grouped substructure 2 632 . . . , and grouped substructure P^{th} 634, based on keys and values of the substructures (e.g., grouping a set of substructures that share the most keys and values). As discussed herein, with the keys and values in the substructure hash map 610 and the overlapping hash map 620, the system 100 may be able to efficiently classify a transaction (e.g., based on how many keys and values of the transaction match with the keys and values in the substructure hash map 610 and the overlapping hash map 620).

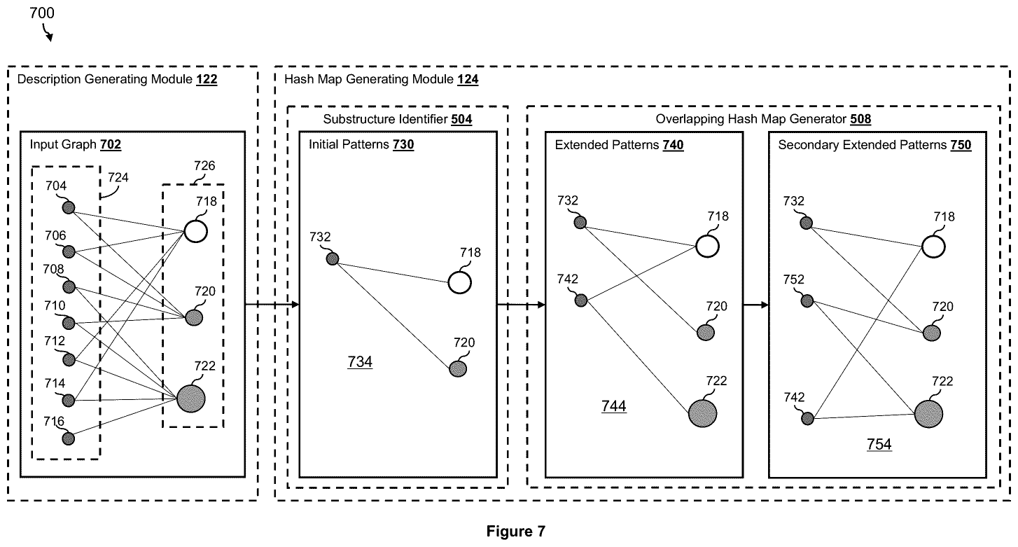

FIG. 7 illustrates an exemplary data flow 700 for identifying a neighbor substructure according to various embodiments of the disclosure. In some embodiments, the exemplary data flow 700 may be performed by the description generating module 122 and the hash map generating module 124. In some embodiments, an input graph 702 for the system 100 may be a bipartite graph. In a process of identifying neighbor substructures, the description generating module 122 may receive the input graph 702 that includes a group of datasets corresponding to a group of transactions. The description generating module 122 may identify at least two nodes connected via a respective edge from each dataset of the group of datasets that represent features in a corresponding transaction. In some embodiments, a structure of the group of datasets may be a bipartite graph including two disjoint sets of nodes connected via edges. For example, a first dataset in the input graph 702 may include nodes 704, 718, 720, in which the node 704 may connect with the nodes 718, 720 via two respective edges. The node 704 may belong to a first set 724 of vertices in the input graph 702, and the nodes 718, 720 may belong to a second set 726 of vertices in the input graph 702, in which the first set 724 and the second set 726 are two disjoint and independent sets. In some embodiments, the first set 724 may include nodes 704, 706, 708, 710, 712, 714, 716 representing Account A, Account B, Account C, Account D, Account E, Account F, and Account G respectively. As discussed in FIG. 3 and FIG. 4, the description generating module 122 may assign Label Blue (Account Number) to the nodes 704, 706, 708, 710, 712, 714, 716 representing the same type of feature (e.g., the account number). In some embodiments, the second set 726 may include nodes 718, 720, 722, in which the node 718 may represent an IP address, the node 720 may represent a bank location, and the node 722 may represent a currency type. The description generating module 122 may assign the nodes 718, 720, 722 three different labels (e.g., Label White (IP Address), Label Orange (Bank Location), and Label Green (Currency Type)).

The description generating module 122 may generate descriptions for the labels assigned for the nodes identified from the input graph 702. In some embodiments, the description generating module 122 may not assign a rank to the labels for the nodes identified from the input graph 702 because of the nature of bipartite graph. As a result, the description generating module 122 may select a random node to be a first node in a sequence of nodes to generate a description until all the nodes in the input graph 702 have been the first node at least once.

The hash map generating module 124 may receive the descriptions generated by the description generating module 122. In some embodiments, the substructure identifier 504 may identify initial patterns 730 (e.g., a basic substructure in a bipartite graph) from the descriptions. For example, an initial pattern 734 may include nodes 732, 718, 720, in which the node 732 may be a paired node combining the node 704 and the node 706 in the input graph 702 because the node 704 and the node 706 both connect to the nodes 718, 720 which indicates that the two substructures share the same description (e.g., Label White-Label Blue-Label Orange). In some embodiments, each initial pattern in the initial patterns 730 may be a substructure that includes three nodes, in which a first node of the three nodes is two edges apart from a final node, and the first node and the final node both belong to either the first set 724 or the second set 726.

In some embodiments, the overlapping hash map generator 508 may identify extended patterns 740 (e.g., an extended substructure extended based on a node in the basic substructure in the bipartite) based on the initial patterns 730. For example, an extended pattern 744 may be a substructure that includes the initial pattern 734 and two other nodes extended two edges from the node 718 in the initial pattern 734, such that the extended pattern 744 may include the nodes 732, 718, 720 in the initial pattern 734, and nodes 742, 722 extended from the node 718. The node 742 may be a paired node combining the node 712 and the node 714 because the node 712 and the node 714 both connect to the nodes 718, 722 in the input graph 702. Furthermore, the overlapping hash map generator 508 may identify secondary extended patterns 750 based on the extended patterns 740. For example, a secondary extended pattern 754 may be a substructure that includes the extended pattern 744 and two other nodes extended two edges from the node 720 in the extended pattern 744, such that the secondary extended pattern 754 includes the nodes 732, 742, 718, 720, 722 in the extended pattern 744 and a node 752 extended from the node 720. The node 752 may be a paired node combining the node 708 and the node 710 because the node 708 and the node 710 both connect to the nodes 720, 722 (e.g., these two substructures have common edges of Label Blue-Label Orange and Label Blue-Label Green). In some embodiments, the overlapping hash map generator 508 may continuously identify a neighbor node (e.g., a node that is two edges apart from a node in the initial pattern 734) for the secondary extended pattern 754 until there is no neighbor node in the input graph 702 that has not been visited. By pairing nodes that have common edges, the system 100 may efficiently detect a specific substructure by consolidating the common edges, such that the computer performance of the system 100 can be significantly improved.

In some embodiments, after exhausting extending potential neighbor nodes in the secondary extended pattern 750, the overlapping hash map generator 508 may generate a key and a value based on a hash for the secondary extended pattern 750. The key includes the starting node, and the value includes the neighborhood node connected to the starting node. In some embodiments, the overlapping hash map generator 508 may perform the same function (e.g., identifying whether the substructures that share the same description (i.e., having the same structure) have overlapped vertices or edges) for both regular graphs and bipartite graph, such that the overlapping hash map generator 508 may consolidate certain patterns (e.g., the repeated/extended patterns) detected in the extended substructures. The overlapping hash map generator 508 may generate a hash map where the key may be a substructure object, and the value may be a set of substructures that have overlapped vertices or edges with the key substructure (e.g., top instances/substructures).

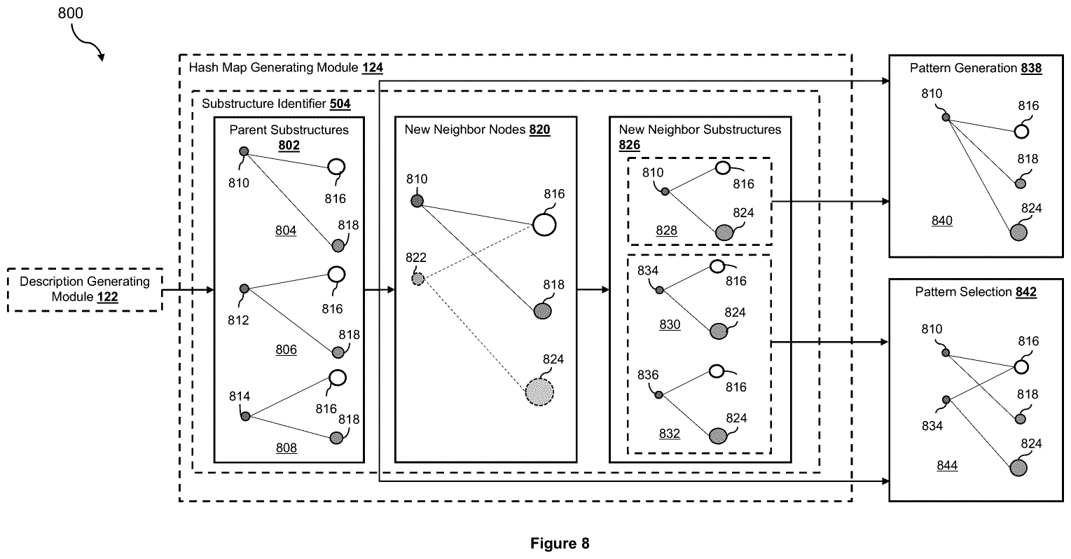

FIG. 8 illustrates an exemplary data flow 800 for generating a new neighbor substructure according to various embodiments of the disclosure. In some embodiments, the exemplary data flow 800 may be performed by the description generating module 122 and the hash map generating module 124, and apply approaches discussed in FIG. 7. As discussed in FIG. 7, in a process of generating the new neighbor substructure, the description generating module 122 may receive the input graph 702 and generate descriptions for the input graph 702. The substructure identifier 504 of the hash map generating module 124 may identify parent substructures 802 (e.g., a parent substructure 1 804, a parent substructure 2 806, and a parent substructure 3 808), from the descriptions. For example, the parent substructure 1 804 may include a paired node 810 combing two nodes that have the same label (Label Blue) and common edges, a node 816 representing Label White, and a node 818 representing Label Orange. The substructure identifier 504 may then identify new neighbor nodes 820 for each parent substructure. For example, the substructure identifier 504 may select the node 816 as a starting node and locate a neighbor node (e.g., a node 824) that is two edges apart from the node 816. During the process of identifying the neighbor node, a potential paired node 822 may also be identified. In some embodiments, the potential paired node 822 may be one or more paired nodes, when there are more than one paired nodes having the same label and common edges connecting the nodes 816, 824. As a result, the substructure identifier 504 may identify new neighbor substructures 826 from the process of identifying the new neighbor nodes 820 for the parent substructures 802, such as a new neighbor substructure 828, including the paired node 810 (Label Blue) connecting the node 816 (Label White) and the node 824 (Label Green). In some embodiments, the potential paired node 822 may include two paired nodes 834, 836 that are the nodes connecting the nodes 816, 824 via two edges, the substructure identifier 504 may identify new neighbor substructures 826 that include a new neighbor substructure 830 including the paired node 834 (Label Blue) connecting the node 816 (Label White) and the node 824 (Label Green), and a new neighbor substructure 832 including the paired node 836 (Label Blue) connecting the node 816 (Label White) and the node 824 (Label Green).

Based on the parent substructures 802 and the new neighbor substructures 826, the hash map generating module 124 may perform a pattern generation 838 to generate a new substructure 840 combining the parent substructure 804 and the new neighbor substructure 828. The new substructure 840 may include the paired node 810 connecting the nodes 816, 818, 824 via three edges. In some embodiments, based on the parent substructures 802 and the new neighbor substructures 826, the hash map generating module 124 may perform a pattern selection 842 to record whether the extended substructures (e.g., the new neighbor substructures 826) are overlapped with each other (e.g., identifying a non-overlapping substructure 844 among the input graph 702). In some embodiments, the hash map generating module 124 may include a pattern selection module that documents extended new edges (e.g., non-overlapping substructures) during the process of extending neighbor nodes from the parent substructures 802, such that the pattern selection module may further select substructures to form a new pattern of substructure.

In some embodiments, the non-overlapping substructure 844 may be a substructure that includes the most nodes but with the least repetitive common edges. In some embodiments, the non-overlapping substructure 844 includes the paired node 810 connecting the nodes 816, 818 via two edges and the paired node 834 connecting the nodes 816, 824. In this case, the system 100 may extend pattern analysis for the transactions in the input graph 702 based on the outputs from the pattern generation 838 and the pattern selection 842 (e.g., detecting a potential connection between two entities that might not have a direct connection in a single transaction).

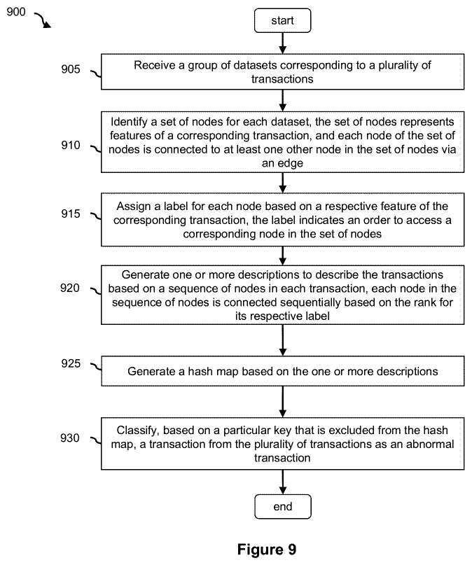

FIG. 9 illustrates an exemplary process 900 for classifying a transaction according to various embodiments of the disclosure. In some embodiments, at least a portion of the process 900 may be performed by the description generating module 122, the hash map generating module 124, and/or the classifying module 126 in the transaction classifying system 100. The process 900 begins by receiving (at step 905) a group of datasets corresponding to a plurality of transactions. For example, each dataset of the group of datasets may correspond to a transaction of the transactions.

The process 900 identifies (at step 910) a set of nodes for each dataset. The set of nodes may represent features of the transaction (e.g., account number, transaction amount, IP address, etc.), and each node of the set of nodes may be connected to at least one other node in the set of nodes via an edge. For example, Node 1 in the set of nodes may be connected to Node 2 in the set of nodes via an edge.

The process 900 assigns (at step 915) a label for each node based on a respective feature of the corresponding transaction. The label may indicate an order to access a corresponding node in the set of nodes. For example, if Node 1 to Node 10 are nodes representing account numbers for User 1 to User 10, a Label Red representing “Account Number” may be assigned to Node 1 to Node 10. In some embodiments, a label may be assigned a rank that indicates the order to access the corresponding node in the set of nodes. For example, Label Red representing “Account Number” may be ranked higher than Label Green representing “Contact Information,” and such that nodes with Label Red will be accessed before nodes with Label Green. In some embodiments, the description generating module 122 may perform step 910 to step 915.

The process 900 generates (at step 920) one or more descriptions to describe or identify the transactions based on a sequence of nodes in each transaction. Each node in the sequence of nodes may be connected sequentially based on the rank for its respective label. For example, the description generating module 122 may select a first node that is assigned a highest-ordered label (e.g., a label ranked the highest among all the labels of the sequence of nodes) from the sequence of nodes. The description generating module 122 may then identify a next node directly connected to the first node. In one embodiment, the next node may be assigned a second-ordered label having a same tier as the highest-ordered label or a next tier lower than the highest-ordered label. For example, Node 1 with the Label Red may be the first node in the sequence of nodes, and the next node directly connected to the first node may be Node 2 that is either with Label Red or Label Green which is ranked second to Label Red. In another embodiment, the next node may be connected directly with most nearby nodes. For example, when Node 1 with Label Red (e.g., the first node) has three nodes that are directly connected to and have the same label, the description generating module 122 may identify which node of the three nodes has the most nearby nodes directly connected to it, and select the node with the most nearby nodes as the next node. In some embodiments, the next node may include a plurality of next nodes. Each next node in the plurality of next nodes is sequentially connected based on respective labels of the plurality of next nodes (e.g., following the criteria discussed in FIG. 2 and above to identify a next node in the plurality of next nodes). Finally, the description generating module 122 may identify a final node which has no nearby nodes that have been assessed, and generate a description based on a sequence of the first node, the next node, and the final node. For example, the description generating module may generate the description describing a route of visiting from the first node to the final node, such as “Label Red-Label Green-Label Yellow.”

The process 900 then generates (at step 925) a hash map based on the one or more descriptions. In one embodiment, generating the hash map may include generating a substructure hash map. For generating the substructure hash map, the hash map generating module 124 may identify a plurality of substructures from the descriptions, and each substructure of the plurality of substructures may include two or more nodes connected via at least one edge (e.g., a parent substructure may include Node 1 (IP address) connected with Node 2 (account number) via one edge). For each substructure of the substructures, the hash map generating module 124 may generate a first key and a first value based on a first hash for the substructure. The first key for the substructure may include a first description of the substructure, and the first value for the substructure may include a first identifier for the substructure. For example, for those substructures that share the same description (e.g., having the same substructure discussed in step 920), those substructures share the same hash (e.g., the same key and value) in the substructure hash map, such that repetitive substructures can be efficiently identified using the substructure hash map.

In some embodiments, generating the hash map may further include generating an overlapping hash map. For generating the overlapping hash map, the hash map generating module 124 may identify a plurality of common edges in the plurality of substructures. For example, Description 1 of Substructure 1 may include Node 1 (Label Red)-Node 2 (Label Green)-Node 3 (Label Yellow), and Description 2 of Substructure 2 may include Node 1 (Label Red)-Node 2 (Label Green)-Node 4 (Label Blue), thus, there is a common edge among Substructure 1 and Substructure 2, which is the edge connecting Node 1 and Node 2. For each common edge of the plurality of common edges, the hash map generating module 124 may generate a second key and a second value based on a second hash for the common edge. The second key for the common edge may include a description of the common edge, and the second value for the common edge may include an identifier for substructures sharing the common edge. For example, Description 1 and Description 2 include Common Edge 1 (e.g., the edge connecting Node 1 and Node 2 in both of Substructure 1 and Substructure 2). The key for Common Edge 1 indicates the edge connecting Node 1 and Node 2 in the overlapping hash map, and the value for Common Edge 1 indicates Substructure 1 and Substructure 2 (e.g., the substructures sharing Common Edge 1).

The process 900 classifies (at step 930), based on a particular key that is excluded from the hash map, a transaction from the plurality of transactions as an abnormal transaction. For example, a particular transaction may include a set of nodes representing all features derived from the particular transaction (e.g., account number, IP address, currency type, etc.). Keys and values for substructures and any common edges with other transactions identified from the particular transaction can be generated using the approach discussed in step 915 to step 925. When the keys and values for the particular transaction cannot be found in the substructure hash map or the overlapping hash map, the transaction classifying system 100 may classify the particular transaction as an abnormal transaction.

In some embodiments, the process 900 may further set at least one parameter for classifying the transaction. The at least one parameter may include at least one of a complexity of the transaction or a number of patterns per iteration to classify the transaction. The process may generate two or more background parameters based on the at least one parameter for classifying the transaction. The two or more background parameters may include at least one of a number of iterations, a number of initial patterns, or a maximum number of iterations extended from the at least one of a complexity of the transaction or a number of patterns per iteration to classify the transaction.

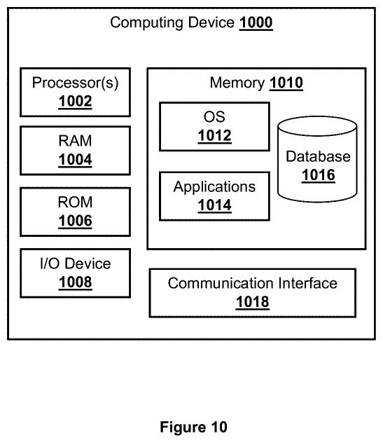

FIG. 10 illustrates a computing device 1000 that may be used to implement the server 120, the user device 110, and the datasets database 130, according to various embodiments of the disclosure. The computing device 1000 may include a processor 1002 for controlling overall operation of the computing device 1000 and its associated components, including a random access memory (RAM) 1004, a read only memory (ROM) 1006, an input/output (I/O) device 1008, a communication interface 1018, and/or a memory 1010. A data bus may interconnect the processor(s) 1002, the RAM 1004, the ROM 1006, the memory 1010, the I/O device 1008, and/or the communication interface 1018. In some embodiments, the computing device 1000 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

The input/output (I/O) device 1008 may include a microphone, keypad, touch screen, and/or stylus motion, gesture through which a user of the computing device 1000 may provide input. The I/O device 1008 may also include one or more of a speaker for providing audio output and a video display device for providing textual, audiovisual, and/or graphical output. Software may be stored within the memory 1010 to provide instructions to the processor(s) 1002 allowing the computing device 1000 to perform various actions. For example, the memory 1010 may store software used by the computing device 1000, such as an operating system (OS) 1012, application programs 1014, an associated internal database 1016, and/or any software that implements the process 900 as described herein. The various hardware memory units in the memory 1010 may include volatile and nonvolatile, removable and non-removable media implemented in any method or technology for storage of information such as computer-readable instructions, data structures, program modules, or other data. The memory 1010 may include one or more physical persistent memory devices and/or one or more non-persistent memory devices. The memory 1010 may include, but is not limited to, a RAM, a ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor(s) 1002.

The communication interface 1018 may include one or more transceivers, digital signal processors, and/or additional circuitry and software for communicating via any network, wired or wireless, using any protocol as described herein.

The processor(s) 1002 may include a single central processing unit (CPU) (e.g., a single-core or multi-core processor, or may include multiple CPUs). The processor(s) 1002 and associated components may allow the computing device 1000 to execute a series of computer-readable instructions to perform some or all of the processes described herein. Although not shown in FIG. 10, various elements within the memory 1010 or other components in computing device 1000, may include one or more caches, for example, CPU caches used by the processor(s) 1002, page caches used by the operating system 1012, disk caches of a hard drive, and/or database caches used to cache content from the database 1016. In various embodiments, the database 1016 may be the datasets database 130 described in FIG. 1. For embodiments including a CPU cache, the CPU cache may be used by the processor(s) 1002 to reduce memory latency and access time. The processor(s) 1002 may retrieve data from or write data to the CPU cache rather than reading/writing to the memory 1010, which may improve the speed of these operations. In some embodiments, a database cache may be created in which certain data from the database 1016 is cached in a separate smaller database in a memory separate from the database 1016, such as in the RAM 1004 or on a separate computing device. For instance, in a multi-tiered application, a database cache on an application server may reduce data retrieval and data manipulation time by not needing to communicate over a network (e.g., the network 140 described in FIG. 1) with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 1000 are described separately, functionality of the various components may be combined and/or performed by a single component and/or multiple computing devices in communication without departing from the invention.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system, comprising:
a non-transitory memory; and
one or more hardware processors coupled with the non-transitory memory and configured to read instructions from the non-transitory memory to cause the system to perform operations comprising:
receiving a group of datasets corresponding to a plurality of transactions, wherein each dataset in the group of datasets comprises a set of nodes representing features of a corresponding transaction from the plurality of transactions, and wherein each node of the set of nodes is labeled that indicates an order to access a corresponding node in the set of nodes;
generating one or more descriptions that describe the plurality of transactions based on a sequence of nodes in the set of nodes for the corresponding transaction, wherein each node in the sequence of nodes is connected based on its respective label;
generating a hash map based on the one or more descriptions, wherein the generating the hash map comprises:
identifying a plurality of instances from the one or more descriptions, wherein each instance of the plurality of instances comprises a substructure including two or more nodes connected via at least one edge; and
for each instance of the plurality of instances: generating a first key and a first value based on a first hash for the instance, wherein the first key for the instance comprises a first description of the instance, and wherein the first value for the instance comprises a first identifier for the instance;
determining that a particular key corresponding to a first transaction of the plurality of transactions is excluded from the hash map, wherein the particular key is different from the first key; and
classifying, based on the determining, the first transaction as a fraudulent transaction.

2. The system of claim 1, wherein the generating the one or more descriptions comprises:
selecting a first node that is assigned a highest-ordered label;
identifying a next node directly connected to the first node, wherein the next node is a) assigned a second-ordered label having a same tier as the highest-ordered label or a next tier lower than the highest-ordered label, or b) connected directly with most nearby nodes; and
identifying a final node, wherein the final node has no nearby node which has not been accessed, wherein the one or more descriptions are generated based on a sequence of the first node, the next node, and the final node.

3. The system of claim 2, wherein the next node comprises a plurality of next nodes each sequentially connected based on respective labels of the plurality of next nodes.

4. The system of claim 1, wherein the generating the hash map further comprises:
for each instance of the plurality of instances: generating a second key and a second value for an instance based on a second hash for the instance, wherein the second key for the instance comprises a second description of the instance, and wherein the second value for the instance comprises a second identifier of the instance.

5. The system of claim 4, wherein the generating the hash map further comprises:
identifying a second instance from the one or more descriptions, wherein the second instance comprises two or more second nodes connected via at least one second edge; and
generating a third key and a third value based on a third hash for the second instance, wherein the third key for the second instance comprises a third description of the second instance, and wherein the third value for the second instance comprises a third identifier of the second instance.

6. The system of claim 5, wherein the two or more second nodes share a common node with the two or more nodes.

7. The system of claim 1, wherein the generating the hash map further comprises grouping instances which have a highest number of common edges, and wherein the grouped instances share the first key and the first value.

8. The system of claim 1, wherein the operations further comprise:
setting at least one parameter for classifying the first transaction, wherein the at least one parameter comprises at least one of a complexity of the first transaction or a number of patterns per iteration to classify the first transaction; and
generating two or more background parameters based on the at least one parameter for classifying the first transaction, wherein the two or more background parameters comprise at least one of a number of iterations, a number of initial patterns, or a maximum number of iterations extended from the at least one of a complexity of the first transaction or a number of patterns per iteration to classify the first transaction.

9. The system of claim 1, wherein each dataset of the group of datasets comprises two nodes connected via a respective edge, and wherein a structure of each dataset from the group of datasets is a bipartite graph comprising two disjoint sets of nodes connected via edges.

10. The system of claim 9, wherein the operations further comprise:
identifying a neighborhood node for a starting node in the bipartite graph as an initial instance, wherein the neighborhood node is at least two edges apart from the starting node; and
generating a fourth key and a fourth value based on a fourth hash for the initial instance, wherein the fourth key comprises the starting node, and wherein the fourth value comprises the neighborhood node connected to the starting node.

11. A method, comprising:
generating one or more descriptions associated with a plurality of transactions based on a sequence of nodes in a set of nodes identified in a corresponding transaction of the plurality of transactions, wherein the set of nodes represents features of the corresponding transaction;
generating a hash map based on the one or more descriptions, wherein the generating the hash map comprises:
identifying a plurality of instances from the one or more descriptions, wherein each instance of the plurality of instances comprises a substructure including two or more nodes connected via at least one edge; and
for each instance of the plurality of instances: generating a first key and a first value based on a first hash for the instance, wherein the first key for the instance comprises a first description of the instance, and wherein the first value for the instance comprises a first identifier for the instance;
determining whether a specified key was used in the generating of the hash map, wherein the specified key is associated with a particular transaction of the plurality of transactions; and
classifying, based on the determining indicating that the specified key was not used in the generating of the hash map, the particular transaction as a fraudulent transaction.

12. The method of claim 11, wherein the generating the one or more descriptions comprises:
assigning a label for each node in the set of nodes based on a respective one of the features of the corresponding transaction, wherein the label indicates an order to access a corresponding node in the set of nodes;
selecting a first node that is assigned a highest-ordered label;
identifying a next node directly connected to the first node, wherein the next node is a) assigned a second-ordered label having a same tier as the highest-ordered label or a next tier lower than the highest-ordered label, or b) connected directly with most nearby nodes; and
identifying a final node, wherein the final node has no nearby node which has not been accessed, wherein the one or more descriptions are generated based on a sequence of the first node, the next node, and the final node.

13. The method of claim 12, wherein the next node comprises a plurality of next nodes each sequentially connected based on respective labels of the plurality of next nodes.

14. The method of claim 11, wherein the generating the hash map further comprises:
for each instance of the plurality of instances: generating a second key and a second value for an instance based on a second hash for the instance, wherein the second key for the instance comprises a second description of the instance, and wherein the second value for the instance comprises a second identifier of the instance.

15. The method of claim 11, further comprising:
setting at least one parameter for classifying the particular transaction, wherein the at least one parameter comprises at least one of a complexity of the particular transaction or a number of patterns per iteration to classify the particular transaction; and
generating two or more background parameters based on the at least one parameter for classifying the particular transaction, wherein the two or more background parameters comprise at least one of a number of iterations, a number of initial patterns, or a maximum number of iterations extended from the at least one of a complexity of the particular transaction or a number of patterns per iteration to classify the particular transaction.

16. A non-transitory machine-readable medium having stored thereon machine-readable instructions executable to cause a machine to perform operations comprising:
generating one or more descriptions that describe a plurality of transactions based on a sequence of nodes in a set of nodes identified in a corresponding transaction of the plurality of transactions, wherein the set of nodes represents features of the corresponding transaction;
generating a hash map based on the one or more descriptions, wherein the generating the hash map comprises:
identifying a plurality of instances from the one or more descriptions, wherein each instance of the plurality of instances comprises a substructure including two or more nodes connected via at least one edge; and
for each instance of the plurality of instances: generating a key and a value based on a hash for the instance, wherein the key for the instance comprises a description of the instance, and wherein the value for the instance comprises an identifier for the instance;
determining, for a given transaction of the plurality of transactions, that a particular key associated with the given transaction is absent from the hash map; and
classifying, based on the determining indicating that the particular key associated with the given transaction is absent from the hash map, the given transaction is associated with fraud.

17. The non-transitory machine-readable medium of claim 16, wherein the generating the one or more descriptions comprises:
assigning a label for each node in the set of nodes based on a respective one of the features of the corresponding transaction, wherein the label indicates an order to access a corresponding node in the set of nodes;
selecting a first node that is assigned a highest-ordered label;
identifying a next node directly connected to the first node, wherein the next node is a) assigned a second-ordered label having a same tier as the highest-ordered label or a next tier lower than the highest-ordered label, or b) connected directly with most nearby nodes; and
identifying a final node, wherein the final node has no nearby node which has not been accessed, wherein the one or more descriptions are generated based on a sequence of the first node, the next node, and the final node.

18. The non-transitory machine-readable medium of claim 17, wherein the next node comprises a plurality of next nodes each sequentially connected based on respective labels of the plurality of next nodes.

19. The non-transitory machine-readable medium of claim 16, wherein a structure of the plurality of transactions is a bipartite graph comprising two disjoint sets of nodes connected via edges.

20. The non-transitory machine-readable medium of claim 19, wherein the operations further comprise:
identifying a neighborhood node for a starting node in the bipartite graph as an initial instance, wherein the neighborhood node is at least two edges apart from the starting node; and
generating a fourth key and a fourth value based on a fourth hash for the initial instance, wherein the fourth key comprises the starting node, and wherein the fourth value comprises the neighborhood node connected to the starting node.
